(19) United States
(12) Patent Application Publication
(10) Pub. No.: US 2026/0024951 A1
(43) Pub. Date: Jan. 22, 2026

(54) COAXIAL CONNECTOR

(71) Applicant: ROSENBERGER NORTH AMERICA AKRON, LLC, Akron, PA (US)

(72) Inventors: Bruce CARDWELL, Lititz, PA (US); Patrick GRESH-SILL, State College, PA (US); Roger SHIREY, Manheim, PA (US); Neal RAMBHIA, Danville, CA (US); Emad SOUBH, Camas, WA (US); Adhish THAKUR, Lancaster, PA (US)

(21) Appl. No.: 19/097,399

(22) Filed: Apr. 1, 2025

Related U.S. Application Data
(60) Provisional application No. 63/672,412, filed on Jul. 17, 2024.

(51) Int. Cl. H01R 24/40; H01R 103/00

(52) U.S. Cl. CPC H01R 24/40; H01R 2103/00

(57) ABSTRACT

A connector for reversibly connecting a coaxial cable with a printed circuit board (“PCB”). Insertion of a coaxial cable into the connection point causes the partial ejection of a conductive pin from inside the connector to press against the electrical pad of a PCB. A serpentine spring formed by the LIGA process is within the connector and provides a normal force that stabilizes the connection between the pin and the printed circuit board. This force also breaks though layers of oxides present on the PCB. Serpentine LIGA springs can be smaller and encounter less mechanical stress than coiled springs, allowing for higher frequency transmission.

### FIELD OF THE INVENTION

The present disclosure is generally directed to cable connectors. More particularly, the subject matter of this application relates to methods and devices to connect coaxial cable to circuit board. Even more particularly, the subject matter of this application pertains to methods and devices to allow high-frequency, solder-free, transmission via a coaxial cable. Yet even more particularly, the subject matter of this application pertains to methods and devices to connect coaxial cable in which a LIGA-spring mediated stable force is utilized to stabilize the connection.

### BACKGROUND OF THE INVENTION

Typically, coaxial cable is comprised of an inner conductor surrounded by a dielectric, which is surrounded by the outer conductor, which is itself surrounded by a protective outer jacket. Coaxial cable is preferred for data transmission because it can conduct high-frequency electrical signals with low signal loss.

Several applications require the connection of a coaxial cable to a printed circuit board (“PCB”), and a few different connectors are designed for this purpose. A most basic way of making a useful connection is by soldering the coax cable to the PCB. Such a connection may have excellent conductivity, but difficulties in making, breaking, and repairing the connection may surpass any advantage to soldering. Solder-free designs are preferred in many situations, particularly when replacing a soldered connection in the field would be prohibitively difficult and time-consuming. Some methods of making solder-free connections utilize coiled springs to provide a force directed toward the electrical pad on a PCB to make a reliable connection between the board and the cable.

As data transmission needs grow, there is an increasing need to utilize higher frequencies of transverse electromagnetic (“TEM”) waves. Simply stated: higher frequencies mean increased data transmission per unit time.

Higher frequencies mean shorter wavelengths, which travel best through smaller geometry transmission lines. Eventually, as frequencies increase, they near the cut-off frequency. At that point, the mode changes from TEM to transverse electric (TE) or transverse magnetic (TM) and reliable measurements and propagation are not viable. This cut-off frequency is inversely proportional to the diameter of the wire (or more accurately for coaxial cable, the inner conductor), so small-diameter wires have a higher cut-off frequency and can propagate higher frequencies without significant signal loss.

Additionally, maximal energy is transferred when the impedance of the source matches the impedance of the load, and since impedance is consistent as long as the ratio of the inner and outer conductors is maintained, it is highly desired to keep the coaxial connector paired to the dimensions of the source. More miniature connectors may be used with smaller cables, allowing more channels per area and allowing ever smaller locations to be probed.

In short, higher frequencies require smaller conductors and connectors.

In some applications, coaxial cables are attached to PCBs via a connector, which is soldered to the PCB. A coaxial cable is then connected to the non-soldered end of the connector. In more common coaxial cable connectors, pins, specifically spring pins are used to generate a normal force from a conductive interconnect to the surface of a PCB. This normal force is needed to break through oxide layers that commonly form on metallic surfaces and to affect a reliable electrical connection from the pin to the PCB. Specifically, the attachment of a coaxial cable causes a spring pin to be pressed against the circuit board. The spring acts as somewhat of a mechanical buffer, and by absorbing some of the force of the connected coaxial cable, it allows for a more consistent force against the PCB and lessens the risk of damage to the board. Spring-mediated connectors are often preferred, however, the practical difficulties in manufacturing increasingly smaller coiled springs limit how small and effective the connector can be. In particular, the minimum bend radius of a coiled spring is roughly 1.5× the wire diameter, For example, with a 0.1016 mm diameter wire (38 AWG), the minimum bend radius is approximately 0.1524 mm. Additionally, springs such as those made from the industry standard beryllium copper wire, need to undergo heat treatment to preserve the strength of the spring. Such treatment requires placement of an ever-shrinking spring in an ever-shrinking form to maintain shape during heating, greatly complicating the manufacture of such small springs. Further, even if smaller coiled springs were to be manufactured, their lifespan would be severely limited due to increased stress. For coiled springs, material stress is equal to force divided by πr\hat{ }2, so the smaller the radius of the spring, the greater the material stress on the spring by a set force, and the fewer compression and extension cycles before the spring fails.

It would be preferable to have a solder-free coaxial cable connector with the advantages of a spring-mediated connector without the practical limitations imposed by the physical requirements of a coiled spring.

### SUMMARY OF THE INVENTION

The subject matter of this application eliminates the sizing issue of spring-mediated coaxial connectors by replacing a coiled spring with an innovative LIGA spring. This spring transmits a consistent force from the inner conductor of a coaxial cable to a connector pin adapted to break through the oxide layers formed on the electrical pad of a PCB. The spring-mediated connection provides a sufficient and consistent force directed toward the PCB to establish and maintain a reliable connection between the coaxial cable and the PCB.

The subject matter of this application comprises a connection assembly with a barrel, a coaxial cable connection portion, a pin portion, an intervening spring portion containing a spring, most preferably a largely planar LIGA spring; and a pin largely contained within said pin portion. When a coaxial cable is inserted into the coaxial cable connection portion, a LIGA spring within the spring portion is compressed and exerts a force on the pin contained within the pin portion, causing the pin to partially protrude, causing a force against the conductive pad of the PCB. The center contact assembly is adapted to conduct a signal from the coaxial cable to the center pin without the signal propagating through the spring.

### BRIEF DESCRIPTION OF DRAWINGS

FIG. 1 is an illustration of a cross-section of coaxial cable connector as disclosed.

FIG. 2 is an illustration of a cross-section of coaxial cable connector in which a coaxial cable has been attached.

FIG. 3 is an illustration of the force communication portion in a spring-relaxed state.

FIG. 4 is a segment of a LIGA spring, enlarged to more clearly show detail.

FIG. 5 is an illustration of the force communication portion in a spring-compressed state.

FIG. 6 is an illustration of a pin, separated from the rest of the coaxial cable connector to show detail.

FIG. 7 is an illustration of a cross-section of the disclosed coaxial cable connector with a coaxial cable connected and with the pin abutting a PCB, the conductive path from the coaxial cable to the pin is illustrated by wavy lines.

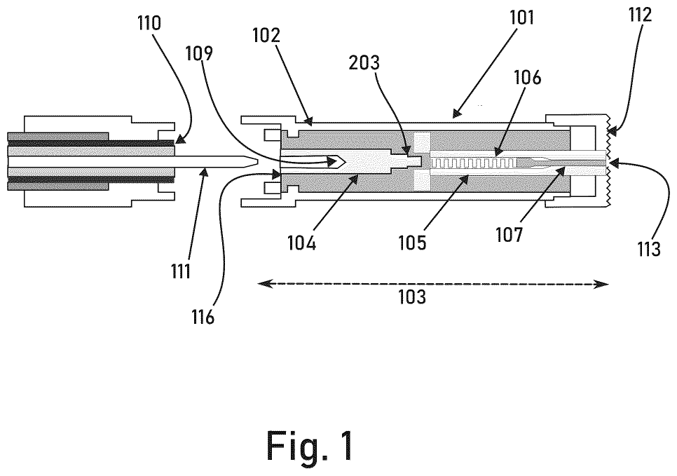

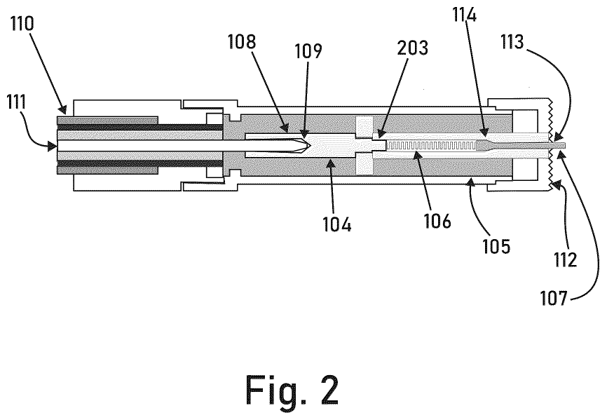

The same reference numbers will be used throughout the drawings to represent the same aspects wherever possible.

### DETAILED DESCRIPTION OF THE INVENTION

While the exemplary embodiments illustrated in the figures and described herein are presently preferred, these embodiments are offered by way of example only. Accordingly, the present application is not limited to a particular embodiment but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes, and omissions may be made in the design, operating conditions, and arrangement of the exemplary embodiments without departing from the scope of the present application.

Uses of the verbs ‘include’ and ‘have’ should be understood to mean ‘comprise,’ i.e., the terms are inclusive and open-ended and do not exclude additional elements or steps. For ease of drafting and understanding the subject matter of this application, the subject matter of this application is discussed and detailed in the context of a connector that reversibly joins a coaxial cable to a printed circuit board, however, the disclosed method may be used in many other suitable environments. Accordingly, the terms “connector,” “cable connector,” and “coaxial cable connector” may be used interchangeably. Further, repeated references are made to a spring as part of the connector. As used herein, a “spring” should be understood to be an elastic structure that deflects when a force is applied and tends to return to its shape when said force is removed.

LIGA is a German acronym for “lithographic, galvanoformung, abformung” which translates in English to “lithography, electroplating, and molding. LIGA is a valuable technology for creating detailed microstructures, but an in-depth discussion of the technique is not needed here to understand the subject matter of this application. LIGA used deep X-ray lithography to form structures with details as fine as a few micrometers. Although references are repeatedly made to the LIGA process, particularly to springs made with the LIGA process, there may be other techniques, known or unknown, that can make the described structures. Any such alternative processes should be deemed to fall within the claims.

The terms “flat” and “planar” may be used interchangeably and should be understood to describe 3D structures of a largely uniform height. Further, a “serpentine” spring or “zig zag” spring describes a planar spring comprised of several meanders formed by span beams and connector beams.

Each drawing callout has three numbers. The first is intended to indicate the figure that first shows the referenced point of interest or shows the referenced point of interest in the clearest manner. Number callouts in the text are not necessarily in order. Drawings are not necessarily to scale and may omit supportive structures that are unclaimed, but that would be obvious to one in a relevant art. Springs are shown with exaggerated inter-meander distances to better show the status of the spring, but the actual number and spacing of meanders shown are not necessarily consistent across the figures, and should not be used to narrow the scope of the claims.

A coaxial cable connector is comprised of a housing having an outer surface (101) and an inner surface (102) defining a space. Said connector further comprises a longitudinal axis (103), a receiving portion (104), and a force communication portion (105). The force communication portion itself comprising a spring (106) and a pin (107).

Said receiving portion of the connector is adapted to move parallel to the longitudinal axis of the connector in response to a force. Movement of the receiving portion toward the force communication portion causes the compression of said spring, which is adapted to transmit a force against the pin of the force communication portion, causing the pin to move along the longitudinal axis and partially exit the coaxial cable connected through a pin exit point (113).

The coaxial cable connector is adapted to reversibly attach to a cable. In a most preferred embodiment, the connector secures a connection between this cable and the electrical pad of a printed circuit board. In most preferred embodiments, this cable is a coaxial cable (110) having a conductive center core (111) that protrudes from the cable insulation. At least a portion of the receiving portion is conductive (e.g., 108) and positioned within the receiving portion so the conductive portion of the cable presses against the conductive portion of the receiving portion. In most highly preferred embodiment, said receiving portion comprises a conductive material, a blind hole (109) adapted to accept the conductive center core, and a terminal structure (203). Attachment of the cable to the connector causes the conductive center core (111) of the cable to press against the conductive portion of the receiving portion, causing the terminal structure (203) of the receiving portion (104) to press against the spring (106) of the force communication portion (105).

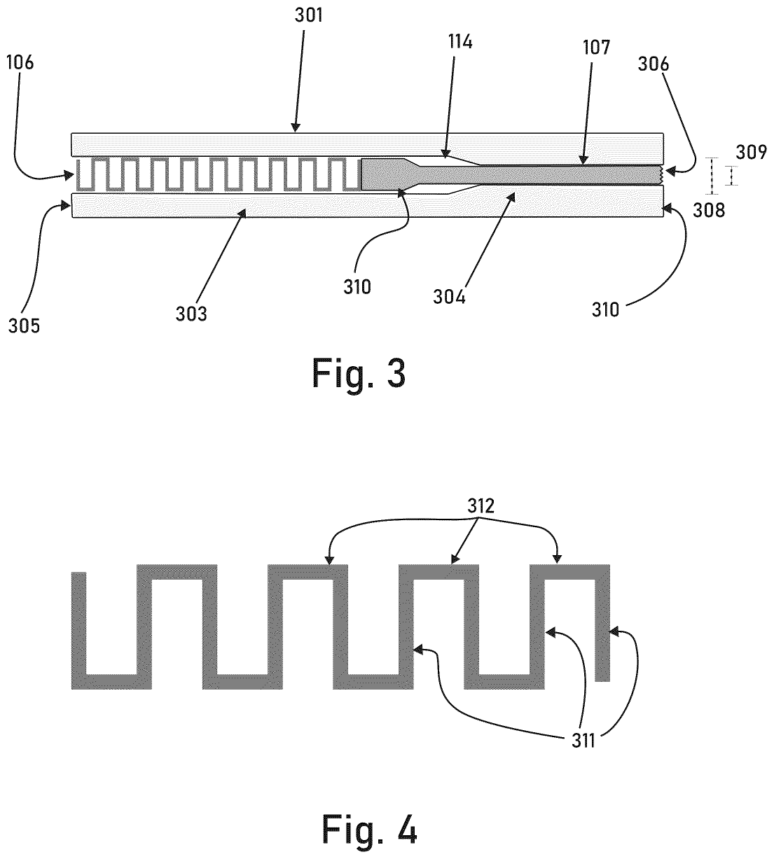

The force communication portion is at least partially comprised of a conductive material. The force communication portion has an outer surface (301) and an inner surface (302), with said inner surface defining a channel having a first region (303) and a second region (304). In all preferred embodiments at least the inner surface of the channel is predominantly conductive. In a most highly preferred embodiment, the channel of the force communication portion comprises a primary, or larger, internal diameter (308) and a secondary, or narrower, internal diameter (309) forming a funnel (114), with the first end of the pin adapted to prevent movement through the funnel (see FIG. 3). The first region of the channel (303) being located near the receiving portion and predominantly contains a spring (106). In most preferred embodiments, the spring is non-conductive. In preferred embodiments, the spring is serpentine and planar and comprises a plurality of meanders (see FIG. 3a), each meander being formed by span beams (e.g., 311) and connector beams (e.g., 312). In the most highly preferred embodiments, the spring is formed by the LIGA technique. Such planar, serpentine LIGA springs being preferred because the LIGA process can be used to create micromechanical structures with very high aspect ratios compared to other technologies, allowing for a much smaller spring than could be accomplished with other methods. This is especially true on a helical, or wound spring when one not only considers that the smaller the bend radius the more stress is placed on a helical spring, but also the tiny structures that would have to be fabricated so that a helical spring could be heat treated so that its tensile strength can be restored due the bending process and the stress introduced therein. A LIGA spring faces none of these challenges and its size can be extended to the micron level. The second region of the channel (304) is located distal to the receiving portion and predominantly contains a pin (107) having a first end (310) and a second end (306). In most preferred embodiments, said second end of the pin comprises multiple projections or points (307). Such projections or points are designed to break through an oxidation layer commonly encountered on the surface of a printed circuit board. Similar projections may be located on the outer surface (112) of the coaxial cable connector surrounding the pin exit point (113). Said pin is comprised of a conductive material and is adapted to move along the longitudinal axis of the connector in response to a force without being fully ejected. In a most highly preferred embodiment, the pin has a primary, or larger, diameter (401) and a secondary, or narrower, diameter (402) positioned such that the larger diameter of the pin is constrained by the narrow diameter of the channel to prevent ejection of the pin.

The receiving portion comprises a first terminus (116) and a second terminus, or terminal structure (203), and the force communication portion also comprises a first terminus (305) and a second terminus (310). The second terminus of the receiving portion and the first terminus of the force communication portion adapted to form a conductive unit when touching. In a preferred embodiment, the second terminus of the receiving portion and the first terminus of the force communication portion are of compatible sizes and shapes that one terminus fits within the other terminus to create a conductive path.

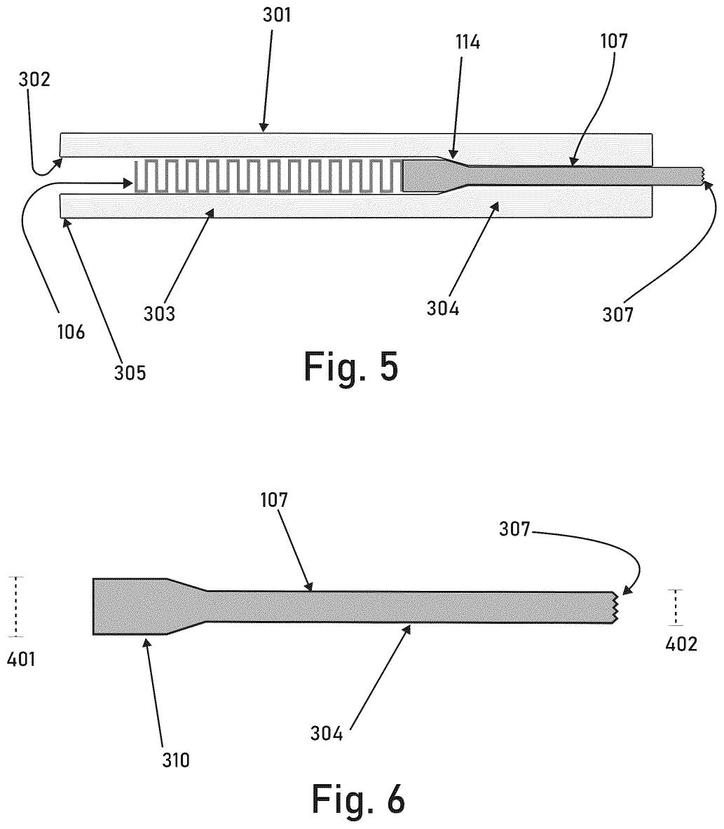

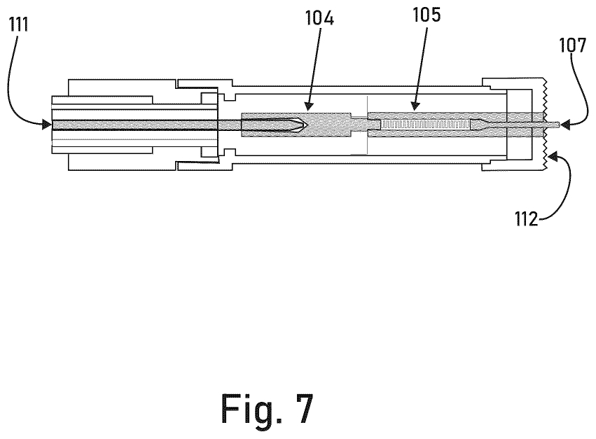

In the most common contemplated use of the subject matter of this application, the connector is attached to a PCB or on a structure surrounding a PCB such that the second end of the pin is near the location on the PCB where contact is to be made, and the longitudinal axis of the connector is largely perpendicular to the plane of the PCB. A coaxial cable is attached to the end of the connector distal to the PCB. This attachment causes the central core of the coaxial cable to press against the receiving portion of the connector, which connects the force communication portion of the connection, and causes compression of the LIGA spring. The LIGA spring acts on the pin held within the force communication portion and causes said pin to be partially ejected from the connector and press against the PCB. Compression of the spring can vary based on the distance the pin has to travel before contacting the target (i.e., electrical pad) thereby the subject matter of this application may be used with a range of such distances without risking damage to the PCB or the connector. The receiving portion, the force communication portion, and the pin are adapted such that a conducive path is established from the coaxial cable, through the receiving portion, through the force communication portion, and through the pin (FIG. 5), to the PCB. The force transmitted through the LIGA spring causes the protrusions of the pin to break through an oxidation layer on the PCB and establishes a connection of suitable fidelity against the PCB.

1. A cable connector comprising an axis, a receiving portion, and a force communication portion comprising a spring, and a pin;
said receiving portion adapted to move parallel to the axis in response to a force, and cause partial compression of the spring, and
directly or indirectly press against said pin, causing the pin to move parallel to the axis.

2. The cable connector of claim 1 in which:
said cable connector is configured to reversibly attach a coaxial cable,
at least a portion of the receiving portion is conductive,
at least a portion of the force communication portion is conductive, and
at least a portion of the pin is conductive.

3. The cable connector of claim 2 in which the spring is non-conductive.

4. The cable connector of claim 2 in which the spring is conductive.

5. The cable connector of claim 2 in which the spring is a serpentine spring.

6. The cable connector of claim 5 in which the spring is formed by the LIGA process.

7. The cable connector of claim 1 in which the cable connector is adapted to reversibly connect a coaxial cable to a printed circuit board.

8. A cable connector comprising a housing having an inner surface defining a space, an outer surface, a longitudinal axis, a receiving portion, and a force communication portion;
the receiving portion being contained within the space and comprising a conductive material, the receiving portion further comprising a first terminal face, and a second terminal face,
said force communication portion comprising a conductive material and having a first terminal face, a body, and a second terminal face;
said body of the force communication portion comprising a channel,
said channel predominantly containing a spring proximal to the receiving portion and a pin distal to the receiving portion,
said spring and said pin each comprising a longitudinal axis parallel to the longitudinal axis of the cable connector;
such receiving portion and spring being so configured that inward pressure acting on the receiving portion exerts pressure on the spring, and
the spring and said pin being so configured that pressure exerted on the spring from the receiving portion causes the pin to move away from the receiving portion along the longitudinal axis of the cable connector.

9. The cable connector of claim 8 in which said spring is a serpentine spring.

10. The cable connector of claim 8 in which said spring is a largely planar LIGA spring.

11. A cable connector comprising a housing having an inner surface defining a space, an outer surface, a longitudinal axis, a receiving portion, and a force communication portion;
the receiving portion being contained within said space and comprising a conductive material, the receiving portion further comprising a first terminal face, a second terminal face, a channel section, and a nipple section,
said channel section comprising a blind hole having a longitudinal axis parallel to the longitudinal axis of the cable connector and further having an opening in the first terminal face of the receiving portion and a depth terminating in a floor,
said nipple section comprising a protrusion forming the second terminal face of the receiving portion;
said force communication portion comprising a conductive material and having a first terminal face, an internal surface defining a channel, and a second terminal face,
said channel comprising a primary internal diameter, and a secondary internal diameter,
said channel having a first opening in the first terminal face and a second opening in the second terminal face,
said channel further comprising a first region and a second region,
said first region of the channel being proximal to the second terminal face of the receiving portion and predominantly containing a largely planar LIGA spring having a longitudinal axis parallel to the longitudinal axis of the cable connector, and
comprised of a non-conductive material, and
said spring having a first end, a second end, and a number of meanders formed by span beams and connector beams,
said span beams being largely perpendicular to the longitudinal axis of the LIGA spring, and
Said connector beams being largely parallel to the longitudinal axis of the LIGA spring;
Said second region of the channel being distal to the second terminal face of the receiving portion and predominantly containing a pin comprised of a conductive material,
said pin having a primary diameter, a flange, a spring face, and a target face
said spring face proximal to the second end of the spring,
said target face of the pin being distal to the second of the spring and proximal to the second terminal face of the channel of the force communication portion,
said flange of the pin and the secondary diameter of the channel of the force communication portion being sized to prevent movement of the flange though the secondary diameter of the channel;
Such that, inward pressure acting on the receiving portion causes the nipple of the receiving portion to press against the first end of the spring, causing the second end of the spring to act up on the first end of the pin, forcing the pin to move outward of the cable connector.

12. The cable connector of claim 11 in which the target face of the pin comprises a plurality of pointed protrusions and further:
said cable connector being mounted on a printed circuit such that the second terminal face of the force communication portion is proximal to a conductive pad on the printed circuit board, and
the cable connector is adapted to create transmit a signal from a coaxial cable to a printed circuit board, such adaptations including
a feature proximal the first terminal face of the receiving portion adapted to attach an end of a coaxial cable such that the core of the cable is inserted into the channel section of the receiving section;
such insertion causing:
the core of the cable to press against the receiving portion, which
abuts the force communication portion and presses against the spring, which
presses against the pin, which
causes the partial ejection of the pin from the channel, which
contacts the conductive pad of the printed circuit board, which
causes the formation of a conductive unit comprised of the receiving portion, the force communication portion and the pin.
